(19) United States
(12) Patent Application Publication
(10) Pub. No.: US 2022/0312308 A1
(43) Pub. Date: Sep. 29, 2022

(54) COMMUNICATION TERMINAL, COMMUNICATION DEVICE, MANAGEMENT SERVER, NON-TRANSITORY COMPUTER-READABLE MEDIUM, AND COMMUNICATION CONTROL METHOD

(71) Applicant: NEC Corporation, Minato-ku, Tokyo (JP)

(72) Inventor: Hirotoshi SAKAI, Tokyo (JP)

(73) Assignee: NEC Corporation, Minato-ku, Tokyo (JP)

(21) Appl. No.: 17/608,862

(22) PCT Filed: Mar. 13, 2020
(86) PCT No.: PCT/JP2020/011120

§ 371 Date: Nov. 4, 2021

(30) Foreign Application Priority Data
May 13, 2019 (JP) 2019-090937

(51) Int. Cl. H04W 48/18; H04W 76/28; H04W 76/15

(52) U.S. Cl. CPC H04W 48/18; H04W 76/28; H04W 76/15

(57) ABSTRACT

To provide a communication terminal that improves convenience of a user who uses a communication terminal adapted to a plurality of communication schemes. A communication terminal (1) includes a first communication unit (2) configured to perform communication according to a first communication scheme, a second communication unit (3) configured to perform communication according to a second communication scheme, and a control unit (4) configured to, when a first period in which the first communication unit (2) performs discontinuous reception and a second period in which the second communication unit (3) performs the discontinuous reception overlap, transition the first communication unit (2) to a sleep state in a third period in which the first period and the second period overlap.

### TECHNICAL FIELD

The present disclosure relates to a communication terminal, a communication device, a management server, and a communication control program.

### BACKGROUND ART

In a communication terminal, when a signal from a wireless communication network is always received, power consumption increases. Accordingly, the communication terminal operates to perform discontinuous reception. Consumed power is reduced to achieve power saving by the discontinuous reception.

There has been known a dual terminal adapted to two wireless communication schemes. In the dual terminal adapted to the two wireless communication schemes, a technique for controlling discontinuous reception of communication units adapted to the wireless communication schemes has been examined (for example, Patent Literature 1). Patent Literature 1 discloses a dual mode terminal that performs control for, when reception timing of discontinuous reception of a first transmitting and receiving unit and reception timing of discontinuous reception of a second transmitting and receiving unit overlap, causing one transmitting and receiving unit to perform the discontinuous reception and shifting timing of the discontinuous reception of the other transmitting and receiving unit.

### CITATION LIST

### Patent Literature

Patent Literature 1: Japanese Unexamined Patent Application Publication No. 2013-247444

### SUMMARY OF INVENTION

### Technical Problem

In the dual terminal adapted to the two wireless communication schemes, it is assumed that, when the communication units adapted to the wireless communication schemes separately perform the discontinuous reception, consumed power cannot be sufficiently reduced. In the technique disclosed in Patent Literature 1, when the reception timing of the discontinuous reception of the first transmitting and receiving unit and the reception timing of the discontinuous reception of the second transmitting and receiving unit overlap, the timing of the discontinuous reception of one transmitting and receiving unit is shifted. Therefore, the two transmitting and receiving units operate to continuously perform the discontinuous reception at the timings. That is, in the technique disclosed in Patent Literature 1, when the timings for performing the discontinuous reception overlap in the two transmitting and receiving units, the discontinuous reception is performed in a pause period when the discontinuous reception is not usually performed. Accordingly, in the technique disclosed in Patent Literature 1, it is likely that the consumed power cannot be reduced. Therefore, when the consumed power cannot be reduced, a user who uses a communication terminal adapted to a plurality of communication schemes cannot use the communication terminal for a long time. User convenience is deteriorated.

The present disclosure has been made in order to solve the problems described above, and one of objectives thereof is to provide a communication terminal, a communication device, a management server, and a communication control program capable of improving convenience of a user who uses a communication terminal adapted to a plurality of communication schemes.

### Solution to Problem

A communication terminal according to the present disclosure includes:

a first communication unit configured to perform communication according to a first communication scheme;

a second communication unit configured to perform communication according to a second communication scheme; and

a control unit configured to, when a first period in which the first communication unit performs discontinuous reception and a second period in which the second communication unit performs the discontinuous reception overlap, transition the first communication unit to a sleep state in a third period in which the first period and the second period overlap.

A communication device according to the present disclosure includes:

a determining unit configured to determine whether a first communication unit included in a first communication terminal, the first communication unit performing communication in a first communication scheme to which the communication device is adapted, is in a sleep state in a period in which the first communication unit performs discontinuous reception; and

a transmitting unit configured to, when the first communication unit is in the sleep state in the period, transmit, via a communication network adapted to a second communication scheme, communication information to a second communication unit that is included in the first communication terminal and communicates in the second communication scheme.

A management server according to the present disclosures includes:

a receiving unit configured to receive position information of a communication terminal;

a determining unit configured to, when a first communication unit included in the communication terminal is located outside a first communication area and a second communication unit included in the communication terminal is located in a second communication area, determine based on base station information concerning a base station with which the first communication unit is communicable and the position information of the communication terminal whether the first communication unit is approaching the first communication area; and

a transmitting unit configured to, when it is determined that the first communication unit is approaching the first communication area, transmit, to the second communication unit, a notification indicating that the first communication unit is approaching the first communication area.

A communication control program according to the present disclosure is a communication control program for causing a computer to execute, when a first period in which a first communication unit that performs communication according to a first communication scheme performs discontinuous reception and a second period in which a second communication unit that performs communication according to a second communication scheme performs the discontinuous reception overlap, transitioning the first communication unit to a sleep state in a third period in which the first period and the second period overlap.

### Advantageous Effects of Invention

According to the present disclosure, it is possible to provide a communication terminal, a communication device, a management server, and a communication control program capable of improving convenience of a user who uses a communication terminal adapted to a plurality of communication schemes.

### BRIEF DESCRIPTION OF DRAWINGS

FIG. 1 is a diagram showing a configuration example of a communication terminal according to a first embodiment.

FIG. 2 is a diagram showing a configuration example of a wireless communication system according to a second embodiment.

FIG. 3 is a diagram for explaining an overview of an operation example of a communication terminal according to the second embodiment.

FIG. 4 is a flowchart showing an operation example of the communication terminal according to the second embodiment.

FIG. 5 is a flowchart showing an operation example of a base station according to the second embodiment.

FIG. 6 is a diagram for explaining an operation example in a case in which a call is originated to the communication terminal according to the second embodiment.

FIG. 7 is a diagram for explaining an operation example in the case in which the call is originated to the communication terminal according to the second embodiment.

FIG. 8 is a sequence chart at a time of call origination to the communication terminal according to the second embodiment.

FIG. 9 is a diagram for explaining a problem matter in a third embodiment.

FIG. 10 is a diagram showing a configuration example of a wireless communication system according to the third embodiment.

FIG. 11 is a diagram showing a configuration example of a communication terminal according to the third embodiment.

FIG. 12 is a diagram showing a configuration example of a management server according to the third embodiment.

FIG. 13 is a flowchart showing an operation example of a wireless communication system according to the third embodiment.

FIG. 14 is a diagram showing a configuration example of a communication terminal according to a modification of the third embodiment.

FIG. 15 is a block diagram illustrating a hardware configuration of the communication terminals and the like according to the embodiments of the present disclosure.

### DESCRIPTION OF EMBODIMENTS

Embodiments of the present disclosure are explained below with reference to the drawings. Note that the following description and the drawings are omitted or simplified as appropriate for clarification of explanation. In the drawings referred to below, the same elements are denoted by the same reference numerals and signs, and redundant explanation is omitted according to necessity.

### First Embodiment

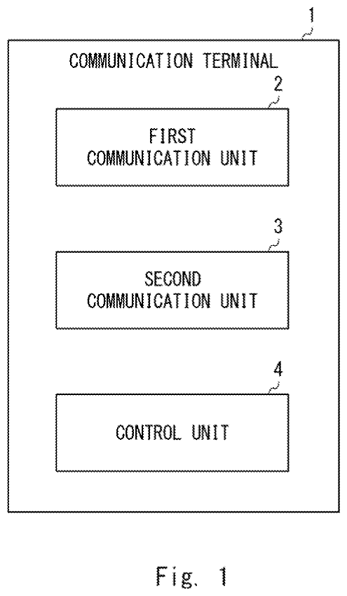

A communication terminal 1 according to a first embodiment is explained with reference to FIG. 1. FIG. 1 is a diagram showing a configuration example of the communication terminal according to the first embodiment. The communication terminal 1 may be a communication terminal such as a smartphone terminal, a tablet terminal, or a transceiver. The communication terminal 1 includes a first communication unit 2, a second communication unit 3, and a control unit 4.

The first communication unit 2 performs communication according to a first communication scheme. The first communication scheme may be an SCPC (Single Channel Per Carrier) scheme or an LTE (Long Term Evolution) scheme. The first communication unit 2 performs discontinuous reception (DRX). That is, the first communication unit 2 performs an operation for repeating a DRX state in which the discontinuous reception is performed and a non-DRX state in which the discontinuous reception is not performed, the non-DRX state being a sleep state.

The second communication unit 3 performs communication according to a second communication scheme. The second communication scheme may be the LTE scheme when the first communication scheme is the SCPC scheme. The second communication scheme may be the SCPC scheme when the first communication scheme is the LTE scheme. The second communication unit 3 also performs the discontinuous reception (DRX). That is, the second communication unit 3 also performs the operation for repeating the DRX state in which the discontinuous reception is performed and the non-DRX state in which the discontinuous reception is not performed, the non-DRX state being the sleep state.

The control unit 4 monitors a first period in which the first communication unit 2 performs the discontinuous reception and a second period in which the second communication unit 3 performs the discontinuous reception. When the first period and the second period overlap, the control unit 4 transitions the first communication unit 2 to the sleep state in a third period in which the first period and the second period overlap.

As explained above, when the period of the discontinuous reception of the first communication unit 2 and the period of the discontinuous reception of the second communication unit 3 overlap, the control unit 4 transitions the first communication unit 2 to the sleep state in the overlapping period. Accordingly, by using the communication terminal 1, when the period of the discontinuous reception of the first communication unit 2 and the period of the discontinuous reception of the second communication unit 3 overlap, it is possible to reduce consumed power compared with when the control unit 4 causes both of the communication units to perform the discontinuous reception in the overlapping period. That is, by using the communication terminal 1 according to the first embodiment, it is possible to reduce consumed power of a communication terminal adapted to a plurality of communication schemes. The user is capable of using the communication terminal for a long time. Therefore, with the communication terminal 1 according to the first embodiment, it is possible to improve convenience of a user who uses a communication terminal adapted to a plurality of communication schemes.

### Second Embodiment

Subsequently, a second embodiment is explained. The second embodiment is a more specific embodiment of the first embodiment.

### <Configuration Example of Wireless Communication System>

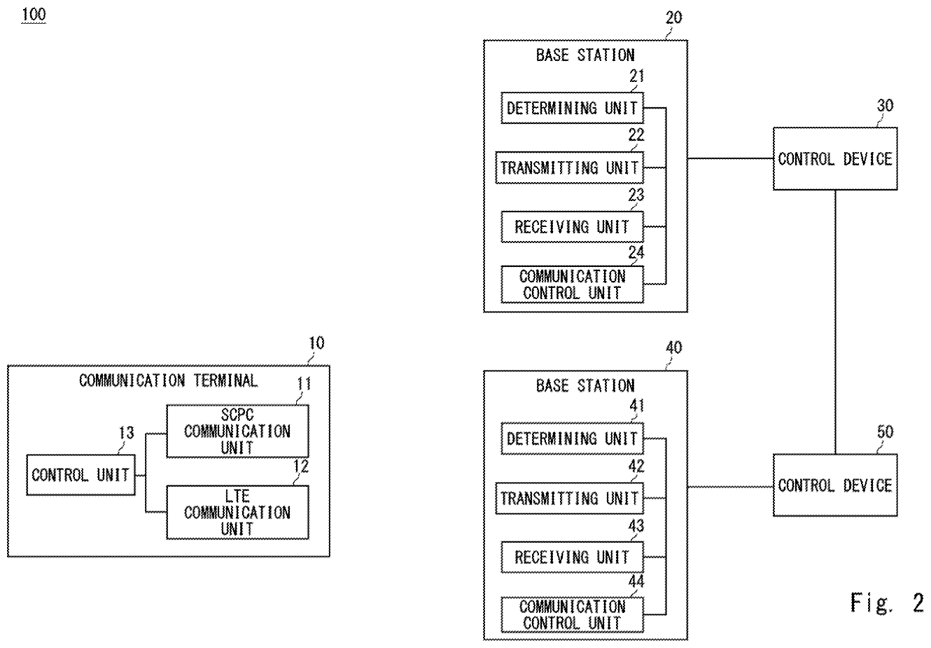

A wireless communication system 100 according to the second embodiment is explained with reference to FIG. 2. FIG. 2 is a diagram showing a configuration example of the wireless communication system according to the second embodiment. The wireless communication system 100 includes a communication terminal 10, a base station 20, a control device 30, a base station 40, and a control device 50.

In FIG. 2, only one communication terminal 10, one base station 20, one control device 30, one base station 40, and one control device 50 are shown. However, the wireless communication system 100 may include pluralities of communication terminals 10, base stations 20, control devices 30, base stations 40, and control devices 50.

The communication terminal 10 is a communication terminal adapted to the SCPC scheme and the LTE scheme and may be called dual mode terminal. The communication terminal 10 may be a communication terminal such as a smartphone terminal, a tablet terminal, and a transceiver.

The base station 20 and the control device 30 are communication devices adapted to the SCPC scheme. The base station 40 and the control device 50 are communication devices adapted to the LTE scheme. The communication terminal 10 performs communication with the base station 20 according to the SCPC scheme and performs communication with the base station 40 according to the LTE scheme.

The base station 20 is a communication device that is connected to the communication terminal 10 according to the SCPC scheme and performs communication. In the SCPC scheme, a usual transmission scheme for always transmitting a downlink radio wave and an unusual transmission scheme for transmitting a radio wave when communication is necessary are possible. However, the base station 20 may be a base station adapted to any of the schemes.

The base station 20 is configured to be capable of transmitting, via the control device 30, the control device 50, and the base station 40, to the communication terminal 10, SCPC communication information for the communication terminal 10 to perform communication according to the SCPC scheme.

The SCPC communication information may include, for example, a synchronization signal for the communication terminal 10 and the base station 20 to establish synchronization. The synchronization signal is a signal for the communication terminal 10 and the base station 20 to establish synchronization when the communication terminal 10 sets a channel corresponding to the base station 20.

The SCPC communication information may include, for example, outgoing call information (call origination information) about an outgoing call (call origination) of a voice communication service from the communication terminal 10 and outgoing call information about an outgoing call to the communication terminal 10. The communication information may include system information about an SCPC network of the SCPC scheme including the communication terminal 10, the base station 40, and the control device 50. Note that the voice communication service in the SCPC scheme may be the same voice communication service as a PTT (Push To Talk) service.

The control device 30 is a communication device that performs communication with the communication terminal 10 via the base station 20. The control device 30 is a line control device and is a device that controls a line in communication of the communication terminal 10 and the base station 20. The control device 30 is configured to be communicable with the control device 50 via a network.

The base station 40 is a communication device that is connected to the communication terminal 10 according to the LTE scheme and performs communication with the communication terminal 10. The base station 40 may be, for example, an NR node B (NR NB), a gNode B (gNB), or an eNode B (evolved Node B).

The base station 40 is configured to be capable of transmitting, via the control device 50, the control device 30, and the base station 20, to the communication terminal 10, LTE communication information for the communication terminal 10 to perform communication by the LTE scheme. The LTE communication information is information included in paging and includes system information about an LTE network of the LTE scheme including the communication terminal 10, the base station 20, and the control device 30. The LTE communication information may include, for example, outgoing call information (call origination information) about an outgoing call (call origination) from the communication terminal 10 and outgoing call information about an outgoing call to the communication terminal 10.

The control device 50 is a communication device that performs communication with the communication terminal 10 via the base station 40 and is a device that controls communication of the communication terminal 10 and the base station 40. The control device 50 may be, for example, an MME (Mobility Management Entity) or an S-GW (Serving Gateway) or may be an EPC (Evolved Packet Core) node including the MME and the S-GW. The control device 50 is configured to be communicable with the control device 30 via a network.

### <Configuration Example of Communication Terminal>

Subsequently, a configuration example of the communication terminal 10 is explained. The communication terminal 10 includes an SCPC communication unit 11, an LTE communication unit 12, and a control unit 13.

The SCPC communication unit 11 is a communication unit that performs communication according to the SCPC scheme. The SCPC communication unit 11 is a communication unit that performs connection to and communication with the base station 20. The SCPC communication unit 11 performs the discontinuous reception (DRX). That is, the SCPC communication unit 11 performs an operation for repeating the DRX state in which the discontinuous reception is performed and the non-DRX state in which the discontinuous reception is not performed, the non-DRX state being the sleep state. The DRX state in which the discontinuous reception is performed is considered to be a state for waiting for SCPC communication information. Therefore, the DRX state may be called waiting state.

The SCPC communication unit 11 repeats the DRX state in which the discontinuous reception is performed and the non-DRX state to be the sleep state using, for example, a timer for managing a discontinuous reception period in which the SCPC communication unit 11 performs the discontinuous reception and a timer for managing a sleep period in which the SCPC communication unit 11 is in the sleep state in which the SCPC communication unit 11 does not perform the discontinuous reception. In the discontinuous reception period, the SCPC communication unit 11 receives the SCPC communication information transmitted from the base station 20.

The LTE communication unit 12 is a communication unit that performs communication according to the LTE scheme. The LTE communication unit 12 is a communication unit that performs connection to and communication with the base station 40. The LTE communication unit 12 performs the discontinuous reception (DRX). That is, the LTE communication unit 12 performs an operation for repeating the DRX state in which the discontinuous reception is performed and the non-DRX state in which the discontinuous reception is not performed, the non-DRX state being the sleep state. The DRX state in which the discontinuous reception is performed is considered to be a state for waiting for LTE communication information. Therefore, the DRX state may be called waiting state.

The LTE communication unit 12 repeats the DRX state in which the discontinuous reception is performed and the non-DRX state to be the sleep state using, for example, a timer for managing a discontinuous reception period in which the LTE communication unit 12 performs the discontinuous reception and a timer for managing a sleep period in which the LTE communication unit 12 is in the sleep state in which the LTE communication unit 12 does not perform the discontinuous reception. In the discontinuous reception period, the LTE communication unit 12 receives the LTE communication information transmitted from the base station 40.

The control unit 13 controls communication of the SCPC communication unit 11 and the LTE communication unit 12. For example, the control unit 13 acquires the timer for managing the discontinuous reception period from the SCPC communication unit 11 to thereby manage the discontinuous reception period in which the SCPC communication unit 11 performs the discontinuous reception. For example, the control unit 13 acquires the timer for managing the discontinuous reception period from the LTE communication unit 12 to thereby manage the discontinuous reception period in which the LTE communication unit 12 performs the discontinuous reception.

The control unit 13 determines whether the discontinuous reception period of the SCPC communication unit 11 and the discontinuous reception period of the LTE communication unit 12 overlap. When determining that the discontinuous reception period of the SCPC communication unit 11 and the discontinuous reception period of the LTE communication unit 12 overlap, the control unit 13 transitions one communication unit to the sleep state in an overlapping period in which the discontinuous reception period of the SCPC communication unit 11 and the discontinuous reception period of the LTE communication unit 12 overlap.

For example, the control unit 13 transitions, of the SCPC communication unit 11 and the LTE communication unit 12, the communication unit having larger consumed power to the sleep state. Note that, for example, the control unit 13 may transition, of the SCPC communication unit 11 and the LTE communication unit 12, the communication unit having a worse communication state to the sleep state or may transition the communication unit having a shorter discontinuous reception period to the sleep state. Alternatively, for example, the control unit 13 may transition, of the SCPC communication unit 11 and the LTE communication unit 12, the communication unit having a longer discontinuous reception period to the sleep state.

The control unit 13 controls the other communication unit to receive communication information that the communication unit transitioned to the sleep state is notified in the overlapping period. That is, the communication unit not transitioned to the sleep state discontinuously receives communication information that the communication unit transitioned to the sleep state should discontinuously receive.

For example, when the control unit 13 transitions the SCPC communication unit 11 to the sleep state, the control unit 13 controls the LTE communication unit 12 to discontinuously receive the SCPC communication information notified in the overlapping period. The LTE communication unit 12 discontinuously receives the SCPC communication information in the overlapping period. For example, when the control unit 13 transitions the LTE communication unit 12 to the sleep state, the control unit 13 controls the SCPC communication unit 11 to discontinuously receive the LTE communication information notified in the overlapping period. The SCPC communication unit 11 discontinuously receives the LTE communication information in the overlapping period.

As explained above, the outgoing call information is included in the SCPC communication information and the LTE communication information. When the outgoing call information is notified to the communication unit transitioned to the sleep state in the overlapping period, the control unit 13 controls the communication unit not transitioned to the sleep state to discontinuously receive the outgoing call information. When the communication unit not transitioned to the sleep state discontinuously receives the outgoing call information, the control unit 13 starts the communication unit transitioned to the sleep state such that a call based on the outgoing call information can be started in the communication unit transitioned to the sleep state.

For example, when the control unit 13 transitions the SCPC communication unit 11 to the sleep state and the outgoing call information to the SCPC communication unit 11 is notified in the overlapping period, the control unit 13 controls the LTE communication unit 12 to discontinuously receive the outgoing call information. When the LTE communication unit 12 discontinuously receives the outgoing call information, the control unit 13 starts the SCPC communication unit 11 such that a call based on the outgoing call information can be started in the SCPC communication unit 11.

For example, when the control unit 13 transitions the LTE communication unit 12 to the sleep state and the outgoing call information to the LTE communication unit 12 is notified in the overlapping period, the control unit 13 controls the SCPC communication unit 11 to discontinuously receive the outgoing call information. When the SCPC communication unit 11 discontinuously receives the outgoing call information, the control unit 13 starts the LTE communication unit 12 such that a call based on the outgoing call information can be started in the LTE communication unit 12.

When the overlapping period ends, the control unit 13 may control the communication unit in the sleep state to transition to the DRX state and carry out the discontinuous reception. Alternatively, when the discontinuous reception period of the SCPC communication unit 11 and the discontinuous reception period of the LTE communication unit 12 overlap, the control unit 13 may keep the sleep state until the discontinuous reception period including the overlapping period of the communication unit in the sleep state ends.

### <Configuration Example of Base Station>

Subsequently, a configuration example of the base station 20 and the base station 40 is explained. The base station 20 and the base station 40 adopt different communication schemes but basically have the same configuration. Therefore, overlapping descriptions are explained while being omitted as appropriate.

First, the base station 20 is explained. The base station 20 includes a determining unit 21, a transmitting unit 22, a receiving unit 23, and a communication control unit 24.

When the SCPC communication information is transmitted to the communication terminal 10, the determining unit 21 determines whether the SCPC communication unit 11 included in the communication terminal 10 is in the sleep state in the discontinuous reception period in which the SCPC communication unit 11 performs the discontinuous reception. That is, the determining unit 21 determines whether the control unit 13 transitions the SCPC communication unit 11 to the sleep state irrespective of the discontinuous reception period in which the SCPC communication unit 11 performs the discontinuous reception.

When the SCPC communication unit 11 is in the sleep state in the discontinuous reception period, the transmitting unit 22 transmits, via an LTE communication network, the SCPC communication information to the LTE communication unit 12 included in the communication terminal 10. When the SCPC communication unit 11 is in the sleep state in the discontinuous reception period, in the communication terminal 10, the control unit 13 is transitioning the SCPC communication unit 11 to the sleep state. The LTE communication unit 12 is performing the discontinuous reception. Accordingly, the transmitting unit 22 transmits (notifies), via the LTE communication network, the SCPC communication information to the LTE communication unit 12. The transmitting unit 22 transmits (notifies) the SCPC communication information to the LTE communication unit 12 via the control device 30, the control device 50, and the base station 40.

When a not-shown communication terminal adapted to the SCPC scheme originates a call to the communication terminal 10, the receiving unit 23 receives outgoing call information transmitted from the not-shown communication terminal adapted to the SCPC scheme to the communication terminal 10. When the receiving unit 23 receives the outgoing call information, the determining unit 21 determines whether the SCPC communication unit 11 is in the sleep state in the discontinuous reception period in which the SCPC communication unit 11 performs the discontinuous reception. When the SCPC communication unit 11 is in the sleep state in the discontinuous reception period, the transmitting unit 22 transmits (notifies) the outgoing call information to the LTE communication unit 12 via the LTE communication network.

When receiving the outgoing call information from the not-shown communication terminal adapted to the SCPC scheme in the discontinuous reception period of the SCPC communication unit 11, after an outgoing call button is pressed in the communication terminal, the communication control unit 24 controls the communication terminal to come into an outgoing call state after elapse of a predetermined time. The predetermined time is a time period from when the transmitting unit 22 starts transmitting the outgoing call information until when the outgoing call information reaches the communication terminal 10 via the LTE communication network.

As explained above, the base station 20 transmits the outgoing call information to the communication terminal 10 via the LTE communication network. Accordingly, it is likely that transmission timing of the outgoing call information shifts between a not-shown SCPC communication terminal on an outgoing call side and the LTE communication unit 12 of the communication terminal 10 on an incoming call side. Therefore, to prevent the transmission timing of the outgoing call information from shifting, the communication control unit 24 adjusts a time period from a time when the outgoing call button is pressed until call origination in the not-shown SCPC communication terminal on the outgoing call side.

Subsequently, the base station 40 is explained. The base station 40 includes a determining unit 41, a transmitting unit 42, a receiving unit 43, and a communication control unit 44.

When the LTE communication information is transmitted to the communication terminal 10, the determining unit 41 determines whether the LTE communication unit 12 included in the communication terminal 10 is in the sleep state in the discontinuous reception period in which the LTE communication unit 12 performs the discontinuous reception.

When the LTE communication unit 12 is in the sleep state in the discontinuous reception period, the transmitting unit 42 transmits (notifies), via an SCPC communication network, LTE communication information to the SCPC communication unit 11 included in the communication terminal 10. The transmitting unit 42 transmits (notifies) the LTE communication information to the SCPC communication unit 11 via the control device 50, the control device 30, and the base station 20.

When a not-shown communication terminal adapted to the LTE scheme originates a call to the communication terminal 10, the receiving unit 43 receives outgoing call information transmitted from the not-shown communication terminal adapted to the LTE scheme to the communication terminal 10. When the receiving unit 43 receives the outgoing call information, the determining unit 41 determines whether the LTE communication unit 12 is in the sleep state in a discontinuous reception period in which the LTE communication unit 12 performs the discontinuous reception. When the LTE communication unit 12 is in the sleep state in the discontinuous reception period, the transmitting unit 42 transmits (notifies) the outgoing call information to the SCPC communication unit 11 via the SCPC communication network.

When the outgoing call information is received from the not-shown communication terminal adapted to the LTE scheme in the discontinuous reception period of the LTE communication unit 12, after an outgoing call button is pressed in the communication terminal, the communication control unit 44 controls the communication terminal to come into the outgoing call state after elapse of a predetermined time. The predetermined time is a time period from when the transmitting unit 42 starts transmitting the outgoing call information until when the outgoing call information reaches the communication terminal 10 via the SCPC communication network.

Note that, when the communication terminal 10 always transitions the SCPC communication unit 11 to the sleep state in the overlapping period, at least the base station 20 only has to include the configuration explained above. That is, when the communication terminal 10 always transitions the SCPC communication unit 11 to the sleep state in the overlapping period, the base station 40 may have a general configuration. When the communication terminal 10 always transitions the LTE communication unit 12 to the sleep state in the overlapping period, at least the base station 40 only has to include a configuration explained below. That is, when the communication terminal 10 always transitions the LTE communication unit 12 to the sleep state in the overlapping period, the base station 20 may have a general configuration. Note that, in the following explanation, it is assumed that the control unit 13 of the communication terminal 10 transitions the SCPC communication unit 11 to the sleep state in the overlapping period.

### <Operation Example of Communication Terminal>

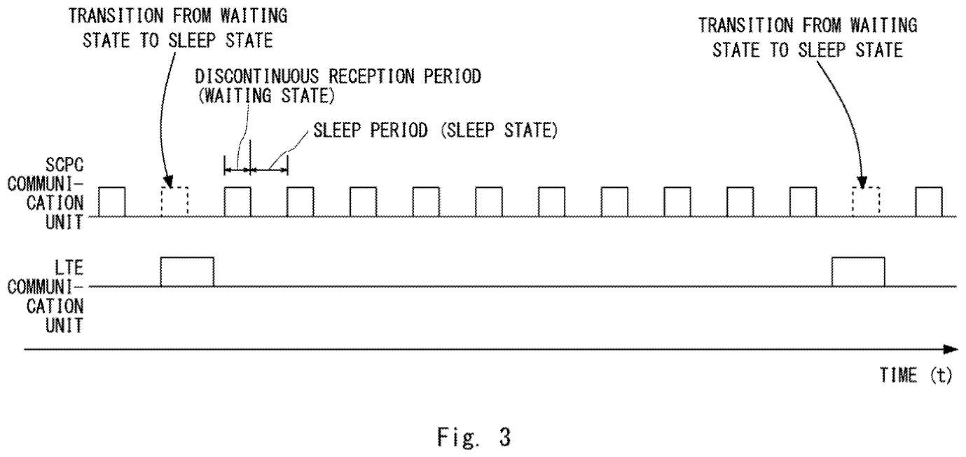

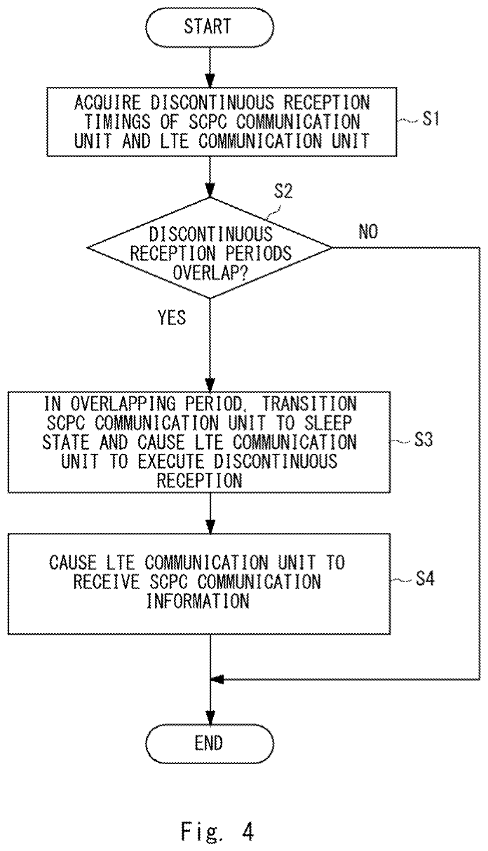

Subsequently, an operation example of the communication terminal 10 according to the second embodiment is explained with reference to FIG. 3 and FIG. 4. FIG. 3 is a diagram for explaining an overview of the operation example of the communication terminal according to the second embodiment. FIG. 4 is a flowchart showing the operation example of the communication terminal according to the second embodiment.

FIG. 3 is explained. FIG. 3 is a timing chart showing states of communication units. In FIG. 3, an arrow from the left to the right indicates a time axis. A state of the SCPC communication unit 11 and a state of the LTE communication unit 12 are described on the time axis. About the states of the communication units, periods in which rectangular blocks are described on reference lines indicate a state and a discontinuous reception period in which the communication units perform the discontinuous reception. The reference lines are lines indicating that consumed power of the communication units are nearly zero. About the states of the communication units, periods in which the rectangular blocks are not described indicate a sleep state and a sleep period in which the communication units do not perform the discontinuous reception.

In FIG. 3, about a state of the SCPC communication unit 11, a second discontinuous reception period from the left and a second discontinuous reception period from the right are discontinuous reception periods in which the discontinuous reception is performed when control by the control unit 13 is absent. The two discontinuous reception periods are periods overlapping the discontinuous reception period of the LTE communication unit 12. Accordingly, when determining that the discontinuous reception periods of both of the communication units overlap, in the periods, the control unit 13 transitions the SCPC communication unit 11 from the discontinuous reception state (the DRX state or the waiting state) to the sleep state.

FIG. 4 is explained.

The control unit 13 acquires discontinuous reception timings from the SCPC communication unit 11 and the LTE communication unit 12 (step S1). For example, the control unit 13 acquires, from the SCPC communication unit 11, a timer for managing the discontinuous reception period and acquires discontinuous reception timing indicating when the discontinuous reception period of the SCPC communication unit 11 is started. For example, the control unit 13 acquires, from the LTE communication unit 12, a timer for managing the discontinuous reception period and acquires discontinuous reception timing indicating when the discontinuous reception period of the LTE communication unit 12 is started.

The control unit 13 determines whether a discontinuous reception period in which the SCPC communication unit 11 performs the discontinuous reception next and a discontinuous reception period in which the LTE communication unit 12 performs the discontinuous reception next overlap (step S2). The control unit 13 determines based on the discontinuous reception timing of the SCPC communication unit 11 and the discontinuous reception timing of the LTE communication unit 12 acquired in step S1 whether the discontinuous reception period of the SCPC communication unit 11 and the discontinuous reception period of the LTE communication unit 12 overlap.

When the discontinuous reception period of the SCPC communication unit 11 and the discontinuous reception period of the LTE communication unit 12 overlap (YES in step S2), in the overlapping period, the control unit 13 transitions the SCPC communication unit 11 to the sleep state and causes the LTE communication unit 12 to execute the discontinuous reception (step S3). In the overlapping period in which the discontinuous reception period of the SCPC communication unit 11 and the discontinuous reception period of the LTE communication unit 12 overlap, the control unit 13 transitions the SCPC communication unit 11 to the sleep state and causes the LTE communication unit 12 to execute the discontinuous reception.

In the overlapping period, the control unit 13 causes the LTE communication unit 12 to receive SCPC communication information received by the SCPC communication unit 11 transitioned to the sleep state (step S4). The LTE communication unit 12 receives the SCPC communication information based on the control from the control unit 13. When the SCPC communication information received by the SCPC communication unit 11 transitioned to the sleep state is outgoing call information, the control unit 13 causes the LTE communication unit 12 to receive the outgoing call information. When the LTE communication unit 12 receives the outgoing call information, the control unit 13 starts the SCPC communication unit 11 to make it possible to start a call based on the outgoing call information.

On the other hand, when the discontinuous reception period of the SCPC communication unit 11 and the disconnection reception period of the LTE communication unit 12 do not overlap in step S2 (NO in step S2), the control unit 13 does not perform the control and ends the processing. That is, the SCPC communication unit 11 and the LTE communication unit 12 respectively perform the discontinuous reception in the discontinuous reception periods and receive the SCPC communication information and the LTE communication information.

### <Operation Example of Base Station>

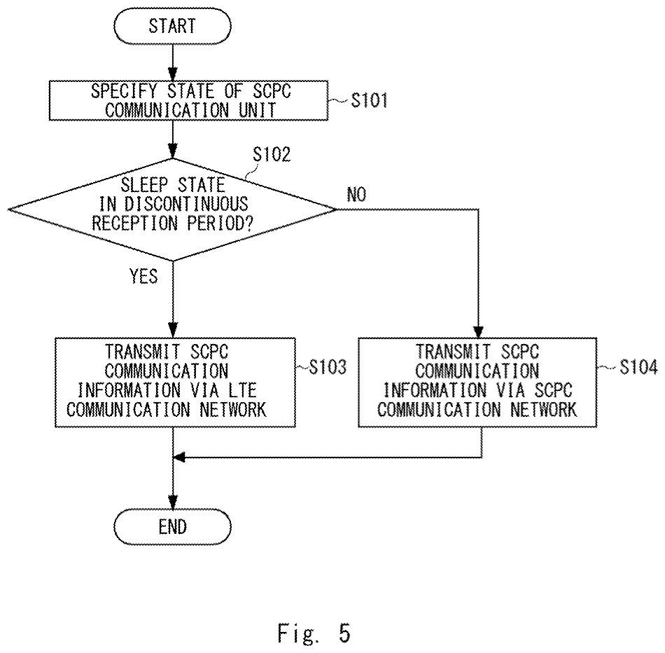

Subsequently, an operation example of the base station 20 is explained with reference to FIG. 5 to FIG. 8. The following explanation is made based on a premise that the control unit 13 transitions the SCPC communication unit 11 to the sleep state in the overlapping period. Because of the premise, FIG. 5 to FIG. 8 are diagrams for explaining the operation example of the base station 20. Note that, when the control unit 13 transitions the LTE communication unit 12 to the sleep state in the overlapping period, the base station 40 carries out the operation example shown in FIG. 5 to FIG. 8.

First, FIG. 5 is explained. FIG. 5 is a flowchart showing the operation example of the base station according to the second embodiment. FIG. 5 is a basic operation example executed when the base station 20 transmits SCPC communication information to the communication terminal 10.

When the SCPC communication information is transmitted to the communication terminal 10, the determining unit 21 specifies a state of the SCPC communication unit 11 of the communication terminal 10 (step S101).

When the SCPC communication information is transmitted to the communication terminal 10, the determining unit 21 may transmit a request to report a state to the communication terminal 10 and determine a state of the SCPC communication unit 11 based on a state report included in a response to the request from the communication terminal 10. Alternatively, when the communication terminal 10 is started, the determining unit 21 may acquire, from the communication terminal 10, a timer for managing discontinuous reception periods of the SCPC communication unit 11 and the LTE communication unit 12 and a timer for managing a sleep period and specify a state of the SCPC communication unit 11 based on the timers.

The determining unit 21 determines whether the SCPC communication unit 11 is in the sleep state in the discontinuous reception period in which the SCPC communication unit 11 performs the discontinuous reception (step S102).

When the determining unit 21 determines that the SCPC communication unit 11 is in the sleep state in the discontinuous reception period (YES in step S102), the transmission unit 22 transmits, via the LTE communication network, the SCPC communication information to the LTE communication unit 12 included in the communication terminal 10 (step S103).

On the other hand, when the determining unit 21 determines that the SCPC communication unit 11 is not in the sleep state in the discontinuous reception period (NO in step S102), the transmitting unit 22 transmits the SCPC communication information to the SCPC communication unit 11 via the SCPC communication network (step S104).

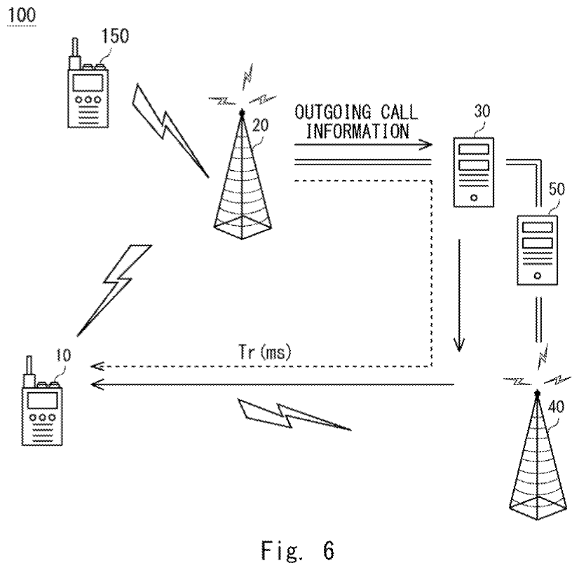

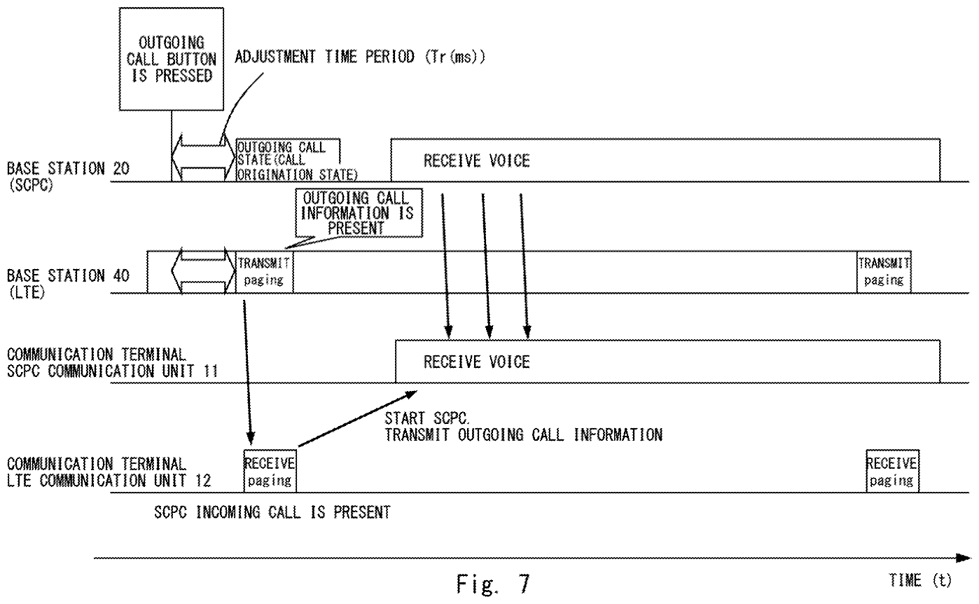

Subsequently, FIG. 6 and FIG. 7 are explained. FIG. 6 and FIG. 7 are diagrams for explaining an operation example in the case in which a call is originated to the communication terminal according to the second embodiment. FIG. 6 is a diagram for explaining an overview of the operation example in the case in which the call is originated to the communication terminal 10.

FIG. 6 shows a configuration example in which a communication terminal 150 that originates a call to the communication terminal 10 is added to the wireless communication system 100 shown in FIG. 2. As a premise, it is assumed that the communication terminal 150 is a communication terminal that performs communication according to the SCPC scheme and the communication terminal 150 originates a call to the communication terminal 10 in an overlapping period in which a discontinuous reception period of the SCPC communication unit 11 and a discontinuous reception period of the LTE communication unit 12 of the communication terminal 10 overlap.

The receiving unit 23 of the base station 20 receives, from the communication terminal 150, outgoing call information to the communication terminal 10. Since the determining unit 21 determines that the SCPC communication unit 11 is in the sleep state in the discontinuous reception period, the transmitting unit 22 transmits the received outgoing call information to the communication terminal 10 via the LTE communication network. Specifically, as indicated by an arrow indicated by a solid line in FIG. 6, the transmitting unit 22 transmits the received outgoing call information to the communication terminal 10 via the control device 30, the control device 50, and the base station 40. As indicated by an arrow indicated by a dotted line in FIG. 6, a time period Tr (ms) is required from when the transmitting unit 22 of the base station 20 starts to transmit the received outgoing call information from the base station 20 until when the outgoing call information reaches the communication terminal 10. Accordingly, a time difference occurs from when a user of the communication terminal 150 presses the outgoing call button until when the outgoing call information reaches the communication terminal 10. Therefore, the communication control unit 24 of the base station 20 performs control to prevent the time difference from occurring from when the user of the communication terminal 150 presses the outgoing call button until when the communication terminal 150 comes into the outgoing call state.

An operation example of the communication control unit 24 of the base station 20 is explained with reference to FIG. 7. FIG. 7 is a diagram showing a timing chart of the base station 20, the base station 40, and the SCPC communication unit 11, and the LTE communication unit 12 of the communication terminal 10. FIG. 7 is also based on the premise that the communication terminal 150 originates a call to the communication terminal 10 in an overlapping period in which a discontinuous reception period of the SCPC communication unit 11 and a discontinuous reception period of the LTE communication unit 12 of the communication terminal 10 overlap.

An arrow at the bottom of FIG. 7 indicates a time axis. A figure at the top of FIG. 7 shows a timing chart of the base station 20 adapted to the SCPC scheme. A second figure from the top of FIG. 7 shows a timing chart of the base station 40 adapted to the LTE scheme. A third figure from the top of FIG. 7 shows a timing chart of the SCPC communication unit 11. A fourth figure from the top of FIG. 7 shows a timing chart of the LTE communication unit 12.

When the outgoing call button is pressed in the communication terminal 150, the base station 20 receives the outgoing call information. The base station 20 transmits the outgoing call information to the communication terminal via the control device 30, the control device 50, and the base station 40. Paging including the outgoing call information is transmitted from the base station 40. As explained with reference to FIG. 6, the time period Tr (ms) is required from when the outgoing call button is pressed in the communication terminal 150 on the outgoing call side until when the paging including the outgoing call information is transmitted from the base station 40. Accordingly, the communication control unit 24 of the base station 20 brings the communication terminal 150 into the outgoing call state at timing when the paging including the outgoing call information is transmitted from the base station 40. That is, after the outgoing call button is pressed in the communication terminal 150, the communication control unit 24 controls the communication terminal 150 to come into the outgoing call state after elapse of the adjustment time period Tr (ms).

When the LTE communication unit 12 of the communication terminal 10 receives the paging including the outgoing call information, in order to recognize that there is an incoming call to the SCPC communication unit 11, the control unit 13 starts the SCPC communication unit 11 such that the SCPC communication unit 11 can perform a call based on the outgoing call information. The SCPC communication unit 11 operates in a callable state by receiving, from the base station 20, a voice signal transmitted from the communication terminal 150.

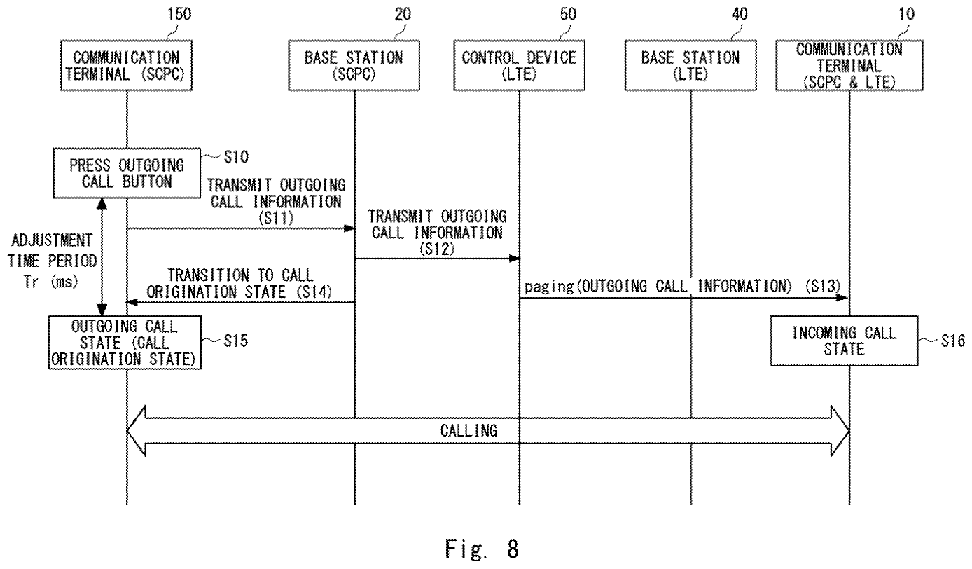

Subsequently, FIG. 8 is explained. FIG. 8 is a sequence chart at a time of call origination to the communication terminal according to the second embodiment. FIG. 8 is also based on the premise that the communication terminal 150 originates a call to the communication terminal 10 in an overlapping period in which a discontinuous reception period of the SCPC communication unit 11 and a discontinuous reception period of the LTE communication unit 12 of the communication terminal 10 overlap.

When the user of the communication terminal 150 presses the outgoing call button (step S10), the communication terminal 150 transmits a message including outgoing call information to the base station 20 (step S11). The base station 20 transmits the message including the outgoing call information to the control device 50 via the control device 30 (step S12). The control device 50 generates paging including the outgoing call information and transmits the paging to the LTE communication unit 12 of the communication terminal 10 via the base station 40 (step S13).

The base station 20 transmits, to the communication terminal 150, transition to a call origination state according to timing when the paging is transmitted from the base station 40 (step S14). In other words, after the outgoing call button is pressed in the communication terminal 150, the base station 20 transmits a message indicating the transition to the call origination state to the communication terminal 150 such that the communication terminal 150 comes into the outgoing call state after elapse of the adjustment time period Tr (ms).

The communication terminal 150 transitions to the outgoing call state according to the message indicating the transition to the call origination state received from the base station 20 (step S15). The communication terminal 10 receives the paging including the outgoing call information and transitions to an incoming call state (step S16). Consequently, the communication terminal 10 and the communication terminal 150 respectively come into the incoming call state and the outgoing call state at substantially the same timing. In the communication terminal 10, when the communication terminal 10 comes into the incoming call state, the SCPC communication unit 11 starts in the callable state and a call is started.

As explained above, when the discontinuous reception period of the SCPC communication unit 11 and the discontinuous reception period of the LTE communication unit 12 overlap, the communication terminal 10 transitions one of the communication units to the sleep state in the overlapping period. Accordingly, the communication terminal 10 is capable of reducing consumed power compared with when both of the SCPC communication unit 11 and the LTE communication unit 12 perform the discontinuous reception. Therefore, the user is capable of using the communication terminal 10 for a long time. Therefore, with the communication terminal 10 according to the second embodiment, it is possible to improve convenience of a user who uses a communication terminal adapted to a plurality of communication schemes.

The base station 20 and the base station 40 respectively determine whether communication units of communication schemes to which the base station 20 and the base station 40 are adapted are in the sleep state in the overlapping period in the communication terminal 10. When the communication units of the communication schemes to which the base station 20 and the base station 40 are adapted are in the sleep state, the base station 20 and the base station 40 respectively transmit communication information to the communication terminal 10 via communication networks adapted to communication schemes different from the communication schemes of the base station 20 and the base station 40. In the communication terminal 10, the other communication unit not in the sleep state receives the communication information received by the communication unit transitioned to the sleep state in the overlapping period. Accordingly, the base station 20 and the base station 40 perform control such that necessary communication information can be acquired even if the communication terminal 10 transitions one communication unit to the sleep state in the overlapping period. Therefore, with the wireless communication system 100, it is possible to continue satisfactory communication while reducing consumed power of the communication terminal 10. That is, with the wireless communication system 100 according to the second embodiment, it is possible to improve convenience of the user who uses the communication terminal adapted to the plurality of communication schemes.

### (Modification)

In the second embodiment explained above, the base station 20 and the base station 40 determine the sleep state of the communication terminal 10 and performs control to transmit the communication information to the communication terminal 10. However, the second embodiment may be modified such that the control device 30 and the control device 50 perform the control explained above.

In this case, the control device 30 only has to include the determining unit 21, the transmitting unit 22, the receiving unit 23, and the communication control unit 24. The control device 50 only has to include the determining unit 41, the transmitting unit 42, the receiving unit 43, and the communication control unit 44. Even such a modification can have the same effects as the effects in the second embodiment.

### Third Embodiment

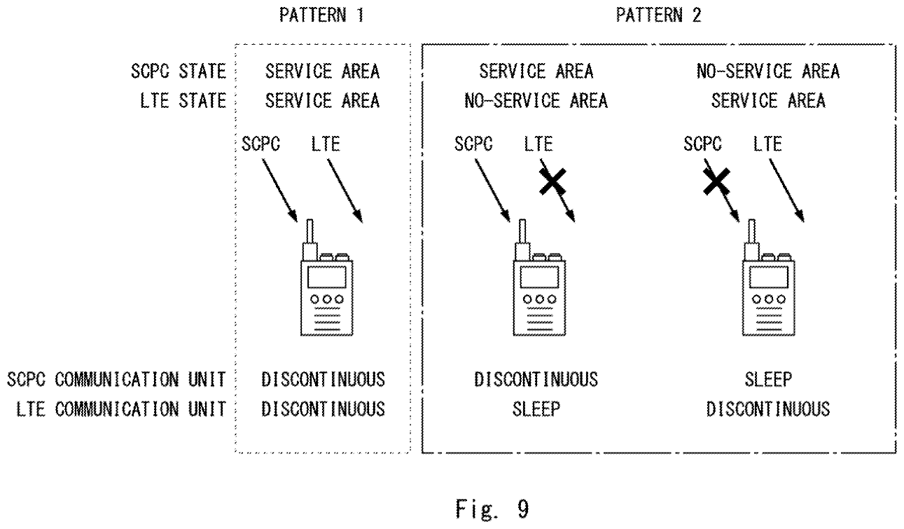

Subsequently, a third embodiment is explained. The third embodiment is an improvement example of the second embodiment. First, a problem matter of the third embodiment is explained with reference to FIG. 9. FIG. 9 is a diagram for explaining the problem matter of the third embodiment.

In a communication terminal including a communication unit that performs discontinuous reception, when the communication unit is present in a position of a service area (a communication area), the communication unit present in the service area operates to perform the discontinuous reception. When the communication unit moves to a no-service area (outside the communication area), the communication terminal does not bring the communication unit moving to the no-service area (outside the communication area) into the waiting state (the DRX state) and always brings the communication unit into the sleep state.

The upper side of FIG. 9 shows an SCPC state and an LTE state of communication units of a communication terminal including an SCPC communication unit and an LTE communication unit and shows whether the communication units are present in the service area (the communication area) or present in the no-service area (outside the communication area). The lower side of FIG. 9 shows operation states of the SCPC communication unit and the LTE communication unit of the communication terminal.

When the SCPC communication unit and the LTE communication unit are present in positions in the service area, the SCPC communication unit and the LTE communication unit perform the discontinuous reception (a pattern 1 in FIG. 9). When one of the SCPC communication unit and the LTE communication unit is present in a position in the service area and the other is present in a position in the no-service area, the one communication unit performs the discontinuous reception and the other comes into the sleep state (a pattern 2 in FIG. 9).

When the communication terminal moves from the no-service area to the service area, such that communication can be recovered, the communication terminal periodically receives a radio wave from a base station and determines based on the received radio wave whether the communication unit present in the no-service area is present in a position in the service area. When the communication unit present in a position in the no-service area is present in a position in the service area, the communication terminal operates to start the discontinuous reception.

The communication unit present in a position in the no-service area periodically receives a radio wave from the base station and determines whether the communication unit is present in a position in the service area. Therefore, it could occur that the communication unit sometimes cannot immediately determine that the communication unit is present in the position in the service area. The communication unit present in a position in the no-service area periodically receives a radio wave from the base station in order to periodically check whether the communication unit is present in a position in the service area. Therefore, consumed power increases.

Further, when the communication unit present in a position in the no-service area is the SCPC communication unit and the SCPC scheme is the unusual transmission scheme, the communication unit needs to establish synchronization with the base station after moving to a position in the service area. However, when the SCPC communication unit is the unusual transmission scheme, since the communication unit cannot immediately determine that the communication unit is present in a position in the service area, the communication unit cannot immediately start communication even if the communication unit moves to a position in the service area. Therefore, in the third embodiment, an objective is to, when one communication unit of the SCPC communication unit and the LTE communication unit moves from the no-service area to the service area, control the communication unit to be able to immediately start communication.

### <Configuration Example of Wireless Communication System>

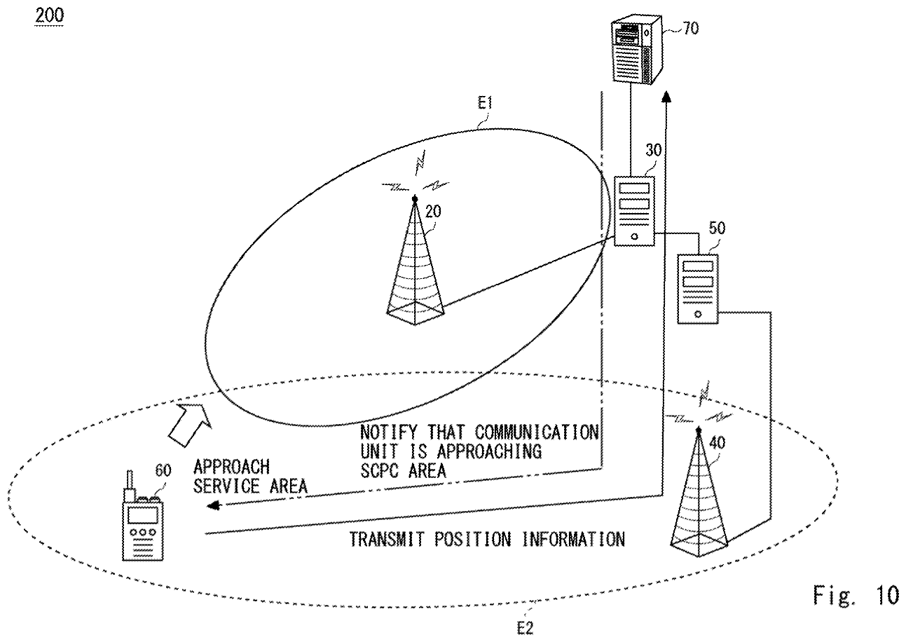

A wireless communication system 200 according to the third embodiment is explained with reference to FIG. 10. FIG. 10 is a diagram showing a configuration example of the wireless communication system according to the third embodiment. In the wireless communication system 200, a management server 70 is added to the configuration of the wireless communication system 100 according to the second embodiment and the communication terminal 10 is replaced with a communication terminal 60. The base station 20, the base station 40, the control device 30, and the control device 50 are basically the same as those in the second embodiment. Accordingly, in the following explanation, explanation is omitted as appropriate about the base station 20, the base station 40, the control device 30, and the control device 50.

The communication terminal 60 corresponds to the communication terminal 10 according to the second embodiment and includes an SCPC communication unit and an LTE communication unit. It is assumed that the communication terminal 60 is present, for example, outside a communication area E1 provided by the base station 20 adapted to the SCPC scheme. That is, the SCPC communication unit of the communication terminal 60 is present in a position in the no-service area (outside the communication area). On the other hand, it is assumed that the communication terminal 60 is present in, for example, a communication area E2 provided by the base station 40 adapted to the LTE scheme. That is, the LTE communication unit of the communication terminal 60 is present in a position in the service area (the communication area).

As explained above, since the SCPC communication unit of the communication terminal 60 is present in a position in the no-service area, the SCPC communication unit comes into the sleep state. Since the LTE communication unit of the communication terminal 60 is present in a position in the service area, the LTE communication unit comes into a state in which the LTE communication unit performs the discontinuous reception. Note that, in the following explanation in this embodiment, it is assumed that the SCPC communication unit of the communication terminal 60 is present in a position in the no-service area. However, the same applies when the LTE communication unit is present in a position in the no-service area. In this case, the SCPC communication unit and the LTE communication unit only have to be replaced with each other.

When one communication unit of the SCPC communication unit and the LTE communication unit is present in a position in the no-service area, the communication terminal 60 acquires position information and transmits the position information to the management server 70 explained below. The communication terminal 60 receives, from the management server 70, a notification indicating that the communication unit present in the position in the no-service area is approaching the service area. Based on the received notification, the communication terminal 60 starts the communication unit transitioned to the sleep state and controls the communication unit to start the discontinuous reception. That is, the communication terminal 60 starts the communication unit present in the position in the no-service area and controls the communication unit to start the discontinuous reception.

The base station 20 is a base station adapted to the SCPC scheme. The base station 20 provides the communication area E1. When the communication terminal 60 is present in the communication area E1, the SCPC communication is possible. When the communication terminal 60 is present outside the communication area E1, the SCPC communication cannot be performed.

The base station 40 is a base station adapted to the LTE scheme. The base station 40 provides the communication area E2. When the communication terminal 60 is present in the communication area E2, the LTE communication is possible. When the communication terminal 60 is present outside the communication area E2, the LTE communication cannot be performed.

The management server 70 is, for example, a management server provided in the SCPC communication network and is connected to the control device 30 via a network. The management server 70 stores base station information concerning base stations adapted to the SCPC scheme including the base station 20. The management server 70 stores base station information concerning base stations adapted to the LTE scheme including the base station 40. Note that the management server 70 may be provided in the LTE communication network or may be provided in a communication network different from the SCPC communication network and the LTE communication network.

The management server 70 receives position information of the communication terminal 60. The management server 70 determines based on the position information of the communication terminal 60 and the base station information of the SCPC scheme whether the communication terminal 60 is approaching the communication area E1 of the base station 20.

When determining that the communication terminal 60 is approaching the communication area E1, the management server 70 transmits, to the communication terminal 60, a notification indicating that the SCPC communication unit of the communication terminal 60 is approaching the communication area E1. Consequently, the SCPC communication unit of the communication terminal 60 does not need to periodically receive a radio wave of the base station 20 and is capable of immediately starting communication when moving to the communication area E1.

### <Configuration Example of Communication Terminal>

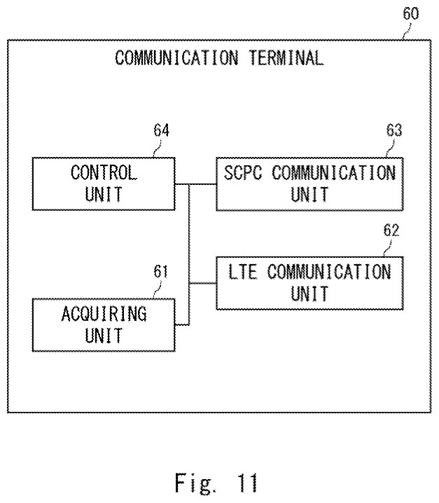

A configuration example of the communication terminal 60 according to the third embodiment is explained with reference to FIG. 11. FIG. 11 is a diagram showing the configuration example of the communication terminal according to the third embodiment. The communication terminal 60 includes an acquiring unit 61, an LTE communication unit 62, an SCPC communication unit 63, and a control unit 64.

When one communication unit of the LTE communication unit 62 and the SCPC communication unit 63 is present in a position in the no-service area (outside the communication area), the acquiring unit 61 acquires position information of the communication terminal 60. In this embodiment, since the SCPC communication unit 63 is located outside the communication area E1, the acquiring unit 61 acquires the position information of the communication terminal 60. The acquiring unit 61 includes, for example, a GPS (Global Positioning System) receiver and acquires the position information of the communication terminal 60 using the GPS receiver. When acquiring the position information of the communication terminal 60, the acquiring unit 61 transmits the acquired position information to the management server 70 via the LTE communication unit 62. Note that, even when both of the LTE communication unit 62 and the SCPC communication unit 63 are present in positions in the service area, the acquiring unit 61 may acquire the position information of the communication terminal 60 and transmit the position information of the communication terminal 60 to the management server 70.

The LTE communication unit 62 corresponds to the LTE communication unit 12 according to the second embodiment and includes the configuration of the LTE communication unit 12. When the SCPC communication unit 63 is present in a position in the no-service area (outside the communication area), the LTE communication unit 62 transmits the position information acquired by the acquiring unit 61 to the management server 70. The LTE communication unit 62 receives, from the management server 70, a notification indicating that the SCPC communication unit 63 is approaching the service area (the communication area). The LTE communication unit 62 transmits the received notification to the control unit 64.

The SCPC communication unit 63 corresponds to the SCPC communication unit 11 according to the second embodiment and includes the configuration of the SCPC communication unit 11. When the LTE communication unit 62 is present in a position in a no-service area (outside the communication area), the SCPC communication unit 63 transmits the position information acquired by the acquiring unit 61 to the management server 70. The SCPC communication unit 63 receives, from the management server 70, a notification indicating that the LTE communication unit 62 is approaching the service area (the communication area). The SCPC communication unit 63 transmits the received notification to the control unit 64. Note that, in this embodiment, since the SCPC communication unit 63 is present outside the communication area E1, which is the service area, the SCPC communication unit 63 is in the sleep state.

The control unit 64 corresponds to the control unit 13 according to the second embodiment and includes the configuration of the control unit 13. The control unit 64 determines whether each of the LTE communication unit 62 and the SCPC communication unit 63 is present in a position in the no-service area (outside the communication area) or present in a position in the service area (the communication area). The control unit 64 transitions the communication unit present in the position of the no-service area to the sleep state. When receiving the notification, the control unit 64 starts the communication unit present in the position in the no-service area (outside the communication area) and causes the communication unit to start the discontinuous reception. In this embodiment, the LTE communication unit 62 receives a notification indicating that the SCPC communication unit 63 approaches the communication area E1, which is the service area (the communication area). When receiving the notification, the control unit 64 starts the SCPC communication unit 63 and causes the SCPC communication unit 63 to start the discontinuous reception.

### <Configuration Example of Management Server>

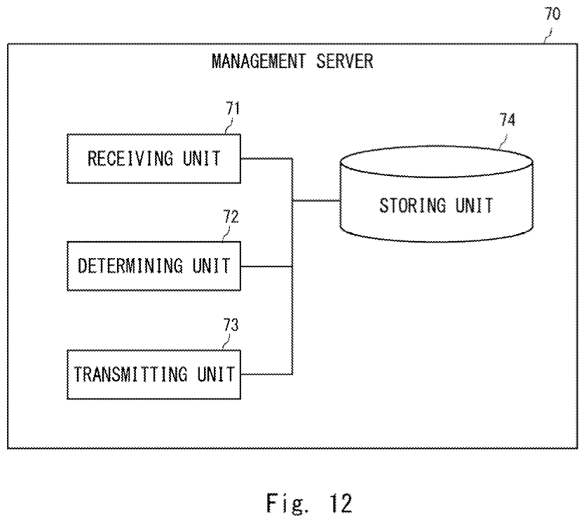

A configuration example of the management server 70 according to the third embodiment is explained with reference to FIG. 12. FIG. 12 is a diagram showing the configuration example of the management server according to the third embodiment. The management server 70 includes a receiving unit 71, a determining unit 72, a transmitting unit 73, and a storing unit 74.

The receiving unit 71 receives position information of the communication terminal 60. The communication unit 71 receives the position information of the communication terminal 60 from, of the LTE communication unit 62 and the SCPC communication unit 63 of the communication terminal 60, the communication unit present in the communication area via a communication network of a communication scheme to which the communication unit is adopted. Since the SCPC communication unit 63 is present in a position in the no-service area (outside the communication area), the management server 70 receives the position information of the communication terminal 60 from the LTE communication unit 62.

When one of the LTE communication unit 62 and the SCPC communication unit 63 is present in a position outside the communication area, the determining unit 72 determines based on information concerning a base station communicable with the communication unit outside the communication area and the acquired position information whether the communication unit present outside the communication area is approaching the communication area. The base station information is stored in the storing unit 74 and, for example, may be a communication area map of the base station 20 or may be position information of the base station 20. The communication area map is obtained by a communication carrier or the like, which manages a communication network, measuring communication quality information in advance and forming a communicable area as a map. Note that, in the following explanation, it is assumed that the base station information is the communication area map.

The determining unit 72 determines, based on the communication unit that transmits the position information, the communication unit present in a position outside the communication area. In this embodiment, since the communication unit that transmits the position information is the LTE communication unit 62, the determining unit 72 determines that the communication unit present in the position outside the communication area is the SCPC communication unit 63.

The determining unit 72 determines based on the communication area map of the base station 20 communicable with the SCPC communication unit 63 and the position information of the communication terminal 60 whether the SCPC communication unit 63 is approaching the communication area E1. For example, when the position of the communication terminal 60 (the SCPC communication unit 63) is present at a distance equal to or smaller than a predetermined distance from an area end of the communication area E1 of the base station 20, the determining unit 72 determines that the SCPC communication unit 63 is approaching the communication area E1. When determining that the SCPC communication unit 63 is approaching the communication area E1, the determining unit 72 generates a notification indicating that the SCPC communication unit 63 is approaching the communication area E1 and transmits the notification to the transmitting unit 73.

Note that the determining unit 72 may estimate a moving direction and a moving distance from transition of the position of the communication terminal 60 and, when a position calculated from the estimated moving direction and the estimated moving distance is located within the communication area E1, determine that the SCPC communication unit 63 is approaching the communication area E1. When the position of the communication terminal 60 is present at a distance equal to or smaller than the predetermined distance from the area end of the communication area E1 and the moving direction is a direction toward the communication area, the determining unit 72 may determine that the SCPC communication unit 63 is approaching the communication area E1.

The transmitting unit 73 transmits the notification generated by the determining unit 72 to the LTE communication unit 62 of the communication terminal 60. When it is determined that the SCPC communication unit 63 is approaching the communication area E1, the transmitting unit 73 transmits, to the LTE communication unit 62, a notification indicating that the SCPC communication unit 63 is approaching the communication area E1.

The storing unit 74 stores the communication area map of the base station 20 and the communication area map of the base station 40.

### <Operation Example of Wireless Communication System>

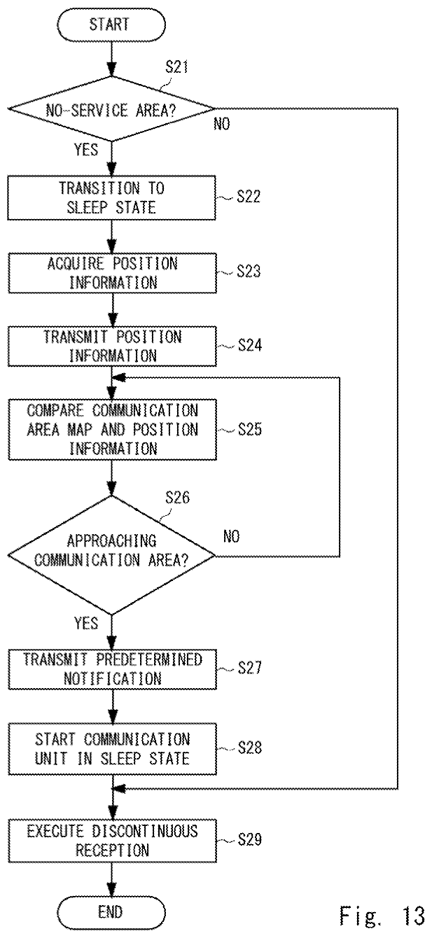

An operation example of the wireless communication system 200 is explained with reference to FIG. 13. FIG. 13 is a flowchart showing the operation example of the wireless communication system according to the third embodiment. Specifically, FIG. 13 is a flowchart for explaining an operation example executed in the communication terminal 60 and the management server 70. Steps S21 to S24, S28, and S29 are executed in the communication terminal 60. Steps S25 to S27 are executed in the management server 70.

The control unit 64 determines whether the LTE communication unit 62 and the SCPC communication unit 63 are present in positions in the no-service area (step S21). The control unit 64 periodically or non-periodically determines whether the LTE communication unit 62 and the SCPC communication unit 63 are present in positions in the no-service area.

Since the SCPC communication unit 63 is present outside communication area E1, the control unit 64 determines that the SCPC communication unit 63 is present in a position in the no-service area (YES in step S21) and transitions the SCPC communication unit 63 to the sleep state (step S22).

Since the LTE communication unit 62 is present in the communication area E2, the control unit 64 determines that the LTE communication unit 62 is absent in a position in the no-service area (NO in step S21) and causes the LTE communication unit 62 to execute the discontinuous reception (step S29). Note that, when the LTE communication unit 62 is already executing the discontinuous reception, the control unit 64 may notify the LTE communication unit 62 that the discontinuous reception is continued or may not perform anything.

The acquiring unit 61 acquires position information of the communication terminal 60 (step S23). The LTE communication unit 62 transmits the position information of the communication terminal 60 to the management server 70 (step S24). Steps S23 and S24 are periodically or non-periodically executed. The acquiring unit 61 periodically or non-periodically acquires position information of the communication terminal 60 and transmits the acquired position information to the management server 70 via the LTE communication unit 62. The receiving unit 71 acquires the position information.

The determining unit 72 compares the acquired position information and the communication area map of the base station 20 stored in the storing unit 74 (step S25) and determines whether the SCPC communication unit 63 is approaching the communication area E1 (step S26). Step S25 and step S26 are executed every time the receiving unit 71 receives position information.

When the determining unit 72 determines that the SCPC communication unit 63 is approaching the communication area E1 (YES in step S26), the transmitting unit 73 transmits a predetermined notification (step S27). The predetermined notification is a notification indicating that the SCPC communication unit 63 is approaching the communication area E1.

On the other hand, when determining that the SCPC communication unit 63 is not approaching the communication area E1 (NO in step S26), the determining unit 72 returns to step S25 and, when the receiving unit 71 receives position information anew, executes step S25.

The control unit 64 starts the SCPC communication unit 63 from the sleep state based on the predetermined notification from the management server 70 indicating that the SCPC communication unit 63 is approaching the communication area E1 (step S28) and causes the SCPC communication unit 63 to execute the discontinuous reception (step S29).

As explained above, when one communication unit of the SCPC communication unit 63 and the LTE communication unit 62 is present in a position in the no-service area (outside the communication area), the communication terminal 60 transmits position information of the communication terminal 60 to the management server 70. The management server 70 determines based on the position information of the communication terminal 60 and the communication area maps of the base station 20 and the base station 40 whether the communication unit present in the position in the no-service area is approaching the communication area. When determining that the communication unit present in the position in the no-service area is approaching the communication area, the management server 70 transmits, to the communication terminal 60, a notification indicating that the communication unit present in the position in the no-service area is approaching the communication area. The communication terminal 60 starts, based on the notification, the communication unit present in the position of the no-service area from the sleep state and controls the communication unit to execute the discontinuous reception.

Accordingly, the communication terminal 60 can determine, without periodically receiving a radio wave of the base station, that the communication unit present in the position in the no-service area (outside the communication area) is approaching the communication area and operates such that the communication unit performs the discontinuous reception. That is, with the communication terminal 60 and the management server 70 according to the third embodiment, since the communication unit present in the position in the no-service area (outside the communication area) may not periodically receive a radio wave of the base station, it is possible to reduce consumed power. Therefore, with the wireless communication system 200 according to the third embodiment, since the user is capable of using the communication terminal 60 for a long time, it is possible to improve convenience of a user who uses a communication terminal adapted to a plurality of communication schemes.

Note that, when one communication unit is present in the position in the no-service area (outside the communication area), the communication terminal 60 acquires the position information. However, the communication terminal 60 is capable of operating with consumed power lower than when the one communication unit periodically operates.

When the communication unit present in position outside the communication area approaches the communication area, the management server 70 transmits the predetermined notification to the communication terminal 60. That is, the management server 70 transmits the predetermined notification to the communication terminal 60 before the communication unit present in the position outside the communication area enters the communication area. The communication terminal 60 causes, based on the notification, the communication unit present in the position in the no-service area to execute the discontinuous reception before entering the communication area. Accordingly, with the wireless communication system 200 according to the third embodiment, when the communication unit moves from the no-service area to the service area (the communication area), the communication unit is capable of immediately performing communication and is capable of providing satisfactory communication to the user. When the communication unit present in the position in the no-service area is the SCPC communication unit 63 and the SCPC scheme is the unusual transmission scheme, the user can establish synchronization with the base station 20 without performing a procedure for establishing synchronization with the base station 20. Therefore, with the wireless communication system 200 according to the third embodiment, it is possible to improve convenience of a user who uses a communication terminal adapted to a plurality of communication schemes.

### (Modification)

In the third embodiment explained above, the management server 70 is explained as determining whether the communication unit present in the position of the no-service area (the communication area) is approaching the communication area. However, the configuration of the management server 70 may be modified to be included in the communication terminal.

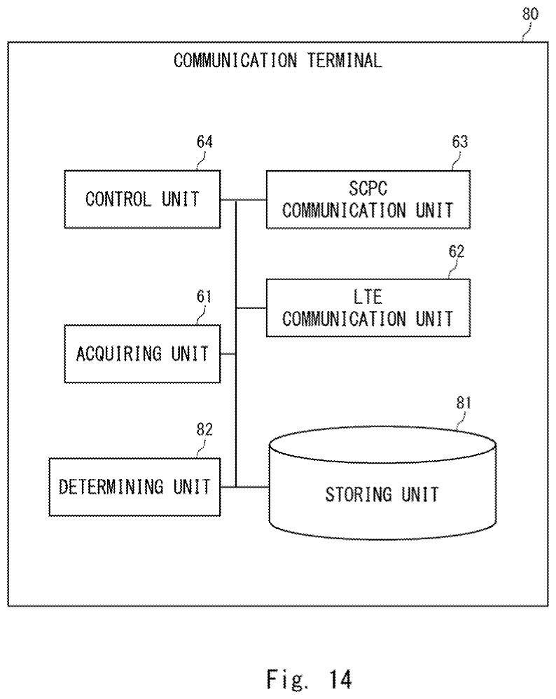

FIG. 14 is a diagram showing a configuration example of a communication terminal according to a modification of the third embodiment. A communication terminal 80 further includes a storing unit 81 and a determining unit 82 in addition to the components of the communication terminal 60 according to the third embodiment.

The storing unit 81 stores the base station information of the base station 20 and the base station 40. Specifically, the storing unit 81 stores the communication area map of the base station 20 and the base station 40.

The determining unit 82 determines based on a communication area map concerning a base station communicable with, of the SCPC communication unit 63 and the LTE communication unit 62, the communication unit present in a position outside the communication area and position information of the communication terminal 80 whether the communication unit present in the position outside the communication area is approaching the communication area. When determining that the communication unit present in the position outside the communication area is approaching the communication area, the determining unit 82 transmits, to the control unit 64, a notification indicating that the communication unit present in the position outside the communication area is approaching the communication area.

Based on the notification from the determining unit 82, the control unit 64 starts the communication unit located outside the communication area and causes the communication unit to start the discontinuous reception.

With the configuration explained above, the modification has the same effects as the effects in the third embodiment. The management server 70 is unnecessary.

### Other Embodiments

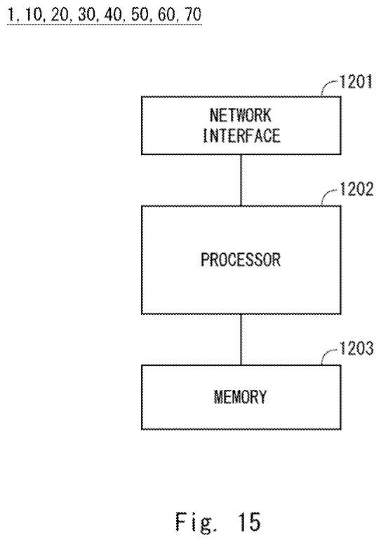

The communication terminals 1, 10, and 60, the base stations 20 and 40, the control devices 30 and 50, and the management server 70 (hereinafter referred to as a communication terminal 1 and the like) may have the following hardware configuration. FIG. 15 is a block diagram illustrating a hardware configuration of the communication terminals and the like according to the embodiments of the present disclosure.

Referring to FIG. 15, the communication terminal 1 and the like include a network interface 1201, a processor 1202, and a memory 1203. The network interface 1201 is used to communicate with other communication devices having a communication function. The network interface 1201 may include a network interface card (NIC) conforming to communication schemes including, for example, IEEE (Institute of Electrical and Electronics Engineers) 802.11 series and IEEE 802.3 series.

The processor 1202 reads out software (a computer program) from the memory 1203 and executes the software to perform the processing of the communication terminal 1 and the like explained with reference to the flowcharts in the embodiments explained above. The processor 1202 may be, for example, a microprocessor, an MPU (Micro Processing Unit), or a CPU (Central Processing Unit). The processor 1202 may include a plurality of processors.

The memory 1203 is configured by a combination of a volatile memory and a nonvolatile memory. The memory 1203 may include a storage disposed to be separated from the processor 1202. In this case, the processor 1202 may access the memory 1203 via a not-shown I/O interface.

In an example shown in FIG. 15, the memory 1203 is used to store a software module group. The processor 1202 can perform the processing of the communication terminal 1 and the like explained in the embodiments by reading out the software module group from the memory 1203 and executing the software module group.

As explained with reference to FIG. 15, each of the processors included in the communication terminal 1 and the like executes one or a plurality of programs including a command group for causing a computer to perform an algorithms explained with reference to the drawings.

In the example explained above, the program can be stored using non-transitory computer-readable media of various types and supplied to the computer. The non-transitory computer-readable media include tangible storage media of various types. Examples of the non-transitory computer-readable media include magnetic recording media (for example, a flexible disk, a magnetic tape, and a hard disk drive) and magneto-optical recording media (for example, a magneto-optical disk). Further, examples of the non-transitory computer-readable media include a CD-ROM (Read Only Memory), a CD-R, and a CD-R/W. Further, examples of the non-transitory computer-readable media include a semiconductor memory. Examples of the semiconductor memory include a mask ROM, a PROM (Programmable ROM), an EPROM (Erasable PROM), a flash ROM, and a RAM (Random Access Memory). The program may be supplied to the computer by transitory computer-readable media of various types. Examples of the transitory computer-readable media include an electric signal, an optical signal, and an electromagnetic wave. The transitory computer-readable media can supply the program to the computer via a wired communication path such as an electric wire or an optical fiber or a wireless communication path.

The invention of this application is explained above with reference to the embodiments. However, the invention of this application is not limited by the embodiments. Various changes that those skilled in the art can understand within the scope of the invention can be made on the configuration and the details of the invention of this application. The present disclosure may be carried out by combining the respective embodiments as appropriate.

A part or all of the embodiments explained above can also be described as indicated by the following supplementary notes but are not limited to the following.

(Supplementary Note 1)

A communication terminal comprising:

first communication means for performing communication according to a first communication scheme;

second communication means for performing communication according to a second communication scheme; and

control means for, when a first period in which the first communication means performs discontinuous reception and a second period in which the second communication means performs the discontinuous reception overlap, transitioning the first communication means to a sleep state in a third period in which the first period and the second period overlap.

(Supplementary Note 2)

The communication terminal described in Supplementary note 1, wherein the second communication means discontinuously receives communication information that the first communication means should discontinuously receive in the third period.

(Supplementary Note 3)

The communication terminal described in Supplementary note 2, wherein

the communication information includes outgoing call information to the communication terminal, and

when the second communication means receives the outgoing call information in the third period, the control means starts the first communication means.

(Supplementary Note 4)

The communication terminal described in any one of Supplementary notes 1 to 3, further comprising acquiring means for acquiring position information of the communication terminal, wherein

one communication means of the first communication means and the second communication means transmits, when another communication means of the first communication means and the second communication means is present in a position outside a communication area, the acquired position information to a management server and receives, from the management server, a notification indicating that the other communication means is approaching the communication area, and

when receiving the notification, the control means starts the other communication means and causes the other communication means to start the discontinuous reception.

(Supplementary Note 5)

The communication terminal described in any one of Supplementary notes 1 to 3, further comprising:

acquiring means for acquiring position information indicating position information of the communication terminal; and

determining means for determining based on base station information concerning a base station communicable with, of the first communication means and the second communication means, the communication means present in a position outside a communication area and the position information whether the communication means present in the position outside the communication area is approaching the communication area, wherein

when determining that the communication means present in the position outside the communication area is approaching the communication area, the control means starts the communication means located outside the communication area and causes the communication means to start the discontinuous reception.

(Supplementary Note 6)

The communication terminal described in Supplementary note 5, wherein the base station information is a communication area map of the base station.

(Supplementary Note 7)

The communication terminal described in any one of Supplementary notes 1 to 6, wherein the control means brings the first communication means into a sleep state in the first period.

(Supplementary Note 8)

The communication terminal described in any one of Supplementary notes 1 to 6, wherein, when the third period ends, the control means starts the first communication means.

(Supplementary Note 9)

The communication terminal described in any one of Supplementary notes 1 to 8, wherein the first communication scheme is one of an SCPC (Sigle Channel Per Carrier) scheme and an LTE (Long Term Evolution) scheme, and the second communication scheme is, of the SCPC and the LTE, a communication scheme different from the first communication scheme.

(Supplementary Note 10)

A communication device comprising:

determining means for determining whether first communication means included in the first communication terminal, the first communication means performing communication in a first communication scheme to which the communication device is adapted, is in a sleep state in a period in which the first communication means performs discontinuous reception; and

transmitting means for, when the first communication means is in the sleep state in the period, transmitting, via a communication network adapted to a second communication scheme, communication information to second communication means included in the first communication terminal, the second communication means communicating in the second communication scheme.

(Supplementary Note 11)

11. The communication device described in Supplementary note 10, wherein

the communication information includes outgoing call information, and

the communication device further comprises:

receiving means for receiving the outgoing call information from a second communication terminal that communicates in the first communication scheme; and

communication control means for, when the outgoing call information is received from the second communication terminal in the period, after an outgoing call button is pressed in the second communication terminal, bringing the second communication terminal into an outgoing call state after elapse of a predetermined time.

(Supplementary Note 12)

The communication device described in Supplementary note 11, wherein the predetermined time is a time period from when the communication device starts transmitting the outgoing call information until when the outgoing call information reaches the first communication terminal via the communication network adapted to the second communication scheme.

(Supplementary Note 13)

A management server comprising:

receiving means for receiving position information of a communication terminal;

determining means for, when first communication means included in the communication terminal is present in a position outside a first communication area and when second communication means included in the communication terminal is present in a position in a second communication area, determining based on base station information concerning a base station with which the first communication means is communicable and the position information of the communication terminal whether the first communication means is approaching the first communication area; and

transmitting means for, when determining that the first communication means is approaching the first communication area, transmitting, to the second communication means, a notification indicating that the first communication means is approaching the first communication area.

(Supplementary Note 14)

The management server described in Supplementary note 13, wherein the base station information is a communication area map of the base station.

(Supplementary Note 15)

A communication control program for causing a computer to execute, when a first period in which first communication means for performing communication according to a first communication scheme performs discontinuous reception and a second period in which second communication means for performing communication according to a second communication scheme performs the discontinuous reception overlap, transitioning the first communication means to a sleep state in a third period in which the first period and the second period overlap.

(Supplementary Note 16)

A communication control method for, when a first period in which first communication means for performing communication according to a first communication scheme performs discontinuous reception and a second period in which second communication means for performing communication according to a second communication scheme performs the discontinuous reception overlap, transitioning the first communication means to a sleep state in a third period in which the first period and the second period overlap.

This application claims priority based on Japanese Patent Application No. 2019-090937 filed on May 13, 2019, the entire disclosure of which is incorporated herein.

### REFERENCE SINGS LIST

1, 10, 60, 80, 150 COMMUNICATION TERMINAL
2 FIRST COMMUNICATION UNIT
3 SECOND COMMUNICATION UNIT
4, 13, 64 CONTROL UNIT
11, 63 SCPC COMMUNICATION UNIT
12, 62 LTE COMMUNICATION UNIT
20, 40 BASE STATION
21, 41, 72, 82 DETERMINING UNIT
22, 42, 73 TRANSMITTING UNIT
23, 43, 71 RECEIVING UNIT
24, 44 COMMUNICATION CONTROL UNIT
30, 50 CONTROL DEVICE
61 ACQUIRING UNIT
70 MANAGEMENT SERVER
74, 81 STORING UNIT

What is claimed is:

1. A communication terminal comprising:
a first communication unit configured to perform communication according to a first communication scheme;
a second communication unit configured to perform communication according to a second communication scheme; and
a control unit configured to, when a first period in which the first communication unit performs discontinuous reception and a second period in which the second communication unit performs the discontinuous reception overlap, transition the first communication unit to a sleep state in a third period in which the first period and the second period overlap.

2. The communication terminal according to claim 1, wherein the second communication unit discontinuously receives communication information that the first communication unit should discontinuously receive in the third period.

3. The communication terminal according to claim 2, wherein
the communication information includes outgoing call information to the communication terminal, and
when the second communication unit receives the outgoing call information in the third period, the control unit starts the first communication unit.

4. The communication terminal according to claim 1 further a comprising acquiring unit configured to acquire position information of the communication terminal, wherein
one communication unit of the first communication unit and the second communication unit transmits, when another communication unit of the first communication unit and the second communication unit is present in a position outside a communication area, the acquired position information to a management server and receives, from the management server, a notification indicating that the other communication unit is approaching the communication area, and
when receiving the notification, the control unit starts the other communication unit and causes the other communication unit to start the discontinuous reception.

5. The communication terminal according to claim 1, further comprising:
an acquiring unit configured to acquire position information indicating position information of the communication terminal; and
a determining unit configured to determine based on base station information concerning a base station communicable with, of the first communication unit and the second communication unit, the communication unit present in a position outside a communication area and the position information whether the communication unit present in the position outside the communication area is approaching the communication area, wherein
when determining that the communication unit present in the position outside the communication area is approaching the communication area, the control unit starts the communication unit located outside the communication area and causes the communication unit to start the discontinuous reception.

6. The communication terminal according to claim 1, wherein the base station information is a communication area map of the base station.

7. The communication terminal according to claim 1, wherein the control unit brings the first communication unit into a sleep state in the first period.

8. The communication terminal according to claim 1, wherein, when the third period ends, the control unit starts the first communication unit.

9. The communication terminal according to claim 1, wherein the first communication scheme is one of an SCPC (Sigle Channel Per Carrier) scheme and an LTE (Long Term Evolution) scheme, and the second communication scheme is, of the SCPC and the LTE, a communication scheme different from the first communication scheme.

10. A communication device comprising:
a determining unit configured to determine whether a first communication unit included in the first communication terminal, the first communication unit performing communication in a first communication scheme to which the communication device is adapted, is in a sleep state in a period in which the first communication unit performs discontinuous reception; and
a transmitting unit configured to, when the first communication unit is in the sleep state in the period, transmit, via a communication network adapted to a second communication scheme, communication information to a second communication unit included in the first communication terminal, the second communication unit communicating in the second communication scheme.

11. The communication device according to claim 10, wherein
the communication information includes outgoing call information, and
the communication device further comprises:
a receiving unit configured to receive the outgoing call information from a second communication terminal that communicates in the first communication scheme; and
a communication control unit configured to, when the outgoing call information is received from the second communication terminal in the period, after an outgoing call button is pressed in the second communication terminal, bring the second communication terminal into an outgoing call state after elapse of a predetermined time.

12. The communication device according to claim 11, wherein the predetermined time is a time period from when the communication device starts transmitting the outgoing call information until when the outgoing call information reaches the first communication terminal via the communication network adapted to the second communication scheme.

13-15. (canceled)

16. A communication control method for, when a first period in which a first communication unit configured to perform communication according to a first communication scheme performs discontinuous reception and a second period in which a second communication unit configured to perform for performing communication according to a second communication scheme performs the discontinuous reception overlap, transitioning the first communication unit to a sleep state in a third period in which the first period and the second period overlap.
